(19) United States
(12) Patent Application Publication
(10) Pub. No.: US 2025/0116168 A1
(43) Pub. Date: Apr. 10, 2025

(54) GAS-LIQUID SPACER FOR REMOVAL OF LIQUID FROM SUBSEA LINES AND ITS RELATED USES

(71) Applicant: PETRÓLEO BRASILEIRO S.A. – PETROBRAS, Rio de Janeiro (BR)

(72) Inventors: Marcia Cristina KHALIL DE OLIVEIRA, Rio de Janeiro (BR); Andre Leal GAIO, Macaé (BR); Humberto Eustaquio LOPES, Rio de Janeiro (BR); Carmen LUCIA DA SILVA TEIXEIRA, Rio de Janeiro (BR); Rogerio LEITE ALVES PINTO, Rio de Janeiro (BR); Vandro FERNANDES MORGADO, Macaé (BR)

(21) Appl. No.: 18/907,784

(22) Filed: Oct. 7, 2024

(30) Foreign Application Priority Data
Oct. 10, 2023 (BR) 1020230210970

(51) Int. Cl. E21B 33/124; C09K 8/524

(52) U.S. Cl. CPC E21B 33/124; C09K 8/524

(57) ABSTRACT

This disclosure finds its field of application in subsea lines, with embodiments aiming to enable the removal of liquids, with direct injection of natural gas produced in the oil and gas production unit itself. The gas-liquid spacer will act as a plug, so that there will be no passage of gas and, consequently—even in conditions of low temperature and increased pressure, with the injection of gas—there will be no risk of blocking the subsea line by the formation of gas hydrates.

### FIELD OF THE DISCLOSURE

This disclosure finds its field of application in subsea lines, aiming to enable the removal of liquids, with direct injection of natural gas produced in the oil and gas production unit itself. The gas-liquid spacer will act as a plug, ensuring that there will be no passage of gas and, consequently—even in conditions of low temperature and increased pressure, with the injection of gas—there will be no risk of blocking the subsea line by the formation of gas hydrates.

The gas-liquid spacer of this disclosure can also be applied in other operations, such as cleaning lines and decommissioning operations.

### BACKGROUND OF THE DISCLOSURE

The solution traditionally used to remove liquids from subsea service lines is based on the injection of nitrogen gas, which is an inert gas and, even in conditions of low temperature and increased pressure, does not offer risk of the formation of gas hydrates.

Hydrates are crystalline solids formed by water and small molecules such as methane, present in natural gas, under high pressure and low temperature conditions and can occur in different offshore production scenarios. The formation of hydrates in production and service lines can cause obstruction of these lines, generating major operational and financial losses.

To prevent the formation of hydrates during liquid removal, pressure/depressurization cycles are performed in the line with nitrogen gas. However, this solution can only be operationalized by contracting a Nitrogen Generating Unit (NGU) that is adapted to the production process.

This procedure, although efficient, is very costly, due to the contracting cost and also due to the dependence on the availability/prioritization of this unit, resulting in long periods of closed well and, consequently, significant oil losses. This condition is even more critical in wells with lower production flow rates or in more distant fields, where prioritization is low.

Thus, the problem of the state of the art related to the presence of undesirable liquids—which is recurrent in the subsea service lines of offshore production units, causing prolonged production shutdowns—has as its traditional solution the injection of natural gas, produced in the production unit itself (SPU). However, this scenario is conducive to the formation of gas hydrates, since the liquid is at a low temperature and the injection of gas favors the increase in pressure, which can cause the total blockage of the line.

Therefore, the search for new alternatives for the removal of liquid from the service line becomes very attractive.

To solve this issue, a liquid-gas spacer was developed, which is the object of this disclosure, capable of keeping the liquid pocket, present in the subsea line, separated from the injected natural gas in operations where it is desired to remove the liquid in ascending flow, without the formation of hydrates and enable the restart of oil production.

The spacer of this disclosure has applications in different oil and gas production scenarios in offshore fields, as it has the potential to be used in non-piggable, flexible and rigid lines; it can pass through diameter restrictions and reductions; it can be soluble in the oil phase; or it can be liquid at temperatures above 60° C.

### STATE OF THE ART

Some documents in the current state of the art have already addressed the problem of the gas-liquid spacer for removing liquid from subsea lines, as will be presented below.

Available works in the state of the art mention gelled fluids, similar to those used in well fracturing operations, acting as a gas-liquid spacer. These fluids, containing xanthan gum or guar gum and other components, are mixed in a support vessel and injected into the lines, as a gel, after crosslinking. Monoethylene glycol (MEG), in gel form, is also known as an alternative gel for liquid removal. In general, large volumes of these gels are required to have the PIG effect, without the commitment to prevent the passage of gas, since they are liquid gels, that is, they are fluid.

In a search of the internal literature (Petrosin-Petrobras' internal reference database), some attempts were identified to prepare PIG gel associated or not with PIG foam, with immersion of PIG foam in a polymer solution or alteration in the geometric configuration of the PIG. However, no viable product was generated for field application. There are reports of the application of foam PIG for removing condensate in piggable gas pipelines and foam PIG for removing paraffin deposits.

However, in the current scenario of applying the gas-liquid spacer, acting as a plug, as will be described by this disclosure, the traditional foam PIG does not apply, because the line is not piggable and this PIG is not soluble in oil at 60° C., nor is it liquid at this temperature. Therefore, when directed into the production column, depending on the amount of PIGs launched, it could eventually cause some impact on the productivity of the reservoir. In addition, the foam webs can allow the passage of gas.

In this regard, it was found that, in 2015, the Company AUBIN (Representative—NORTECH) provided different models of gel PIG for CENPES to carry out tests in a flow unit and evaluate the performance in removing paraffin deposits.

The products evaluated were made of rubber products and were stable at high temperatures.

Other studies found in the literature show the use of PIG gel in piggable lines and always associated with the use of metal spacers between fluids, as shown in FIG. 1, reported by Uzu, 2000 i (SPE 66068).

A search on the Halliburton website found the SureGL™ technology, which includes gel and viscous fluids for different applications, as shown in Table 1.

TABLE 1
Gel and viscous fluid options described on the Halliburton website

| | | Transport | | | non- | | | | |
|---|---|---|---|---|---|---|---|---|---|
| Trademark | | debris | | Paraffin/ | piggable | | Product | Service | |
| name | Base fluid | light | heavy | asphaltene | line | Isolation | separation | change | Lubrication |
| SureGL ™ | fresh/saline | | ● | ◯ | ● | ● | ● | ● | |
| T | water and | | | | | | | | |
| | MEG | | | | | | | | |
| SureGL ™ | hydrocarbon | | ● | ● | ● | | ◯ | | |
| M | | | | | | | | | |
| SureGL ™ | fresh/saline | | ◯ | ◯ | ◯ | | ● | ● | |
| H | water | | | | | | | | |
| SureGL ™ | fresh/saline | ● | | | | | | ◯ | ● |
| A | water | | | | | | | | |
| SureGL ™ | fresh water | ● | | | | | | | ● |
| X | | | | | | | | | |

● best option
◯ Recommended under certain conditions

From Table 1, it is possible to verify that, for non-piggable lines, the SureGL™ T and M products are suggested as the best options for application scenarios in seawater, MEG and hydrocarbon. It is also mentioned in the technical sheet that the composition can be adjusted according to the application. These products sold by Halliburton are supplied as liquids and must be prepared just before application.

It should be noted that the aforementioned website does not mention issues related to application in scenarios with reduced and/or increased diameter, nor to solubility in oil. Analysis of the information showed that the products presented act as a plug with the consistency of a liquid gel (presenting fluidity) that settles on the lower generator of the line.

Regarding patent documents, document CN 115059440 describes a large-scale multi-dimensional profile adjustment method for a water injection well of an oil field. The method comprises any of the following steps: leakage stoppage: injecting ultra-high concentration gel into a water injection well, continuing to inject displacement fluid, and recovering the water injection after shutting in the well for 2 to 6 days; a high gas-liquid ratio foam gel plug and a high-concentration gel plug are injected into the water injection well in sequence or alternately, the high-concentration gel plug is used for completion, then the displacement liquid continues to be injected, and the water injection is recovered after the well is shut in for 3 to 10 days; in-depth profile control: a high gas-liquid ratio foam gel plug and a low gas-liquid ratio foam gel plug are sequentially or alternately injected into the water injection well, then a high-concentration gel plug is injected, the displacement liquid continues to be injected, and the water injection is recovered after the well is shut in for 3 to 10 days; and profile and displacement control are conducted, specifically: a high gas-liquid ratio and low gas-liquid ratio foam gel plug and a high-concentration gel plug are sequentially or alternately injected into the water injection well, then the low-concentration gel plug and the high-concentration gel plug are injected, and the displacement liquid continues to be injected.

However, the method described by the aforementioned document addresses gelled fluids for injection into water wells and other applications, but with purposes entirely different from this disclosure. Furthermore, in none of its applications is there any commitment that the fluid will prevent the passage of gas in subsea lines containing liquid, an essential characteristic for the gas-liquid spacer product developed.

Document BR 112017019884-3 relates to fracturing fluids and methods of treating hydrocarbon formations, in particular, fracturing fluids containing superabsorbent polymers and their use in fracturing applications. This document also describes the use of a fracturing composition comprising a carrier fluid, containing a linear guar, and a superabsorbent polymer present in an effective amount to reduce fluid loss during a fracturing operation; in which said superabsorbent polymer can be used to replace the linear guar-based fluid in fracturing applications, since it is capable of absorbing large quantities of aqueous liquids (such as water, brine, acid or base, with swelling); and already addresses the formation of a gel or viscous material that retains the absorbed fluid under a certain pressure or temperature; and that the fracturing composition may be a liquid or a foam, in which the carrier fluid may be foamed with a liquid hydrocarbon or a gas, which may be natural gas.

However, the fracturing composition of BR 112017019884-3 may be a liquid or a foam and the carrier fluid may be foamed with a liquid hydrocarbon or a gas or liquefied gas, such as nitrogen, carbon dioxide, natural gas, air or a combination comprising at least one of the above. Fracturing fluids are liquid or gel (semi-solid) and used in wells, and, differently, this disclosure addresses the use of a solid spacer in subsea lines. Furthermore, the fluids are prepared at the time of injection. The gas-liquid spacer, which is the object of this disclosure, in addition to being solid, is not used in wells and will be supplied ready.

The article Trapped Annular Pressure Mitigation A Spacer Fluid That Shrinks Update, published in OnePetro in 2008, specifically addressed a foam-based spacer fluid that shrinks. It also tested TAP spacer formulations based on composition, temperature history, and time, and reported on a test designed to show that its inhibited spacer, as shipped to the platform (without initiator), was very stable. In addition, the aforementioned article reported on the importance of performing a complete risk analysis before using MMA or other reactive materials in a spacer fluid.

However, the spacer fluid discussed in the aforementioned article is positioned behind the casing and is capable of shrinking by 20% to allow less compressible fluids, which are confined in the annular space, to expand due to increased temperature without allowing the pressure to increase catastrophically. Thus, such spacer fluid behaves like a fluid, and is not related to the function of the spacer of this disclosure, which would be to prevent the passage of gas during its movement in the underwater line, in addition to having been designed for use in well completion stages.

Therefore, the aforementioned documents differ from this disclosure because they deal with fluids prepared at the time of injection and address liquid or gel (semi-solid) spacers, while the spacer of this disclosure, in addition to being solid, will be supplied ready.

Thus, given the difficulties present in the aforementioned state of the art, that is, related to the presence of undesirable liquids—which is recurrent in the subsea service lines of offshore production units, causing prolonged oil and gas production shutdowns—the need arose to develop a liquid-gas spacer capable of keeping the liquid pocket, present in the subsea line, separated from the natural gas injected in operations, without the formation of gas hydrates and enabling the restart of oil production. As reported above, the current state of the art does not have the unique characteristics that will be presented in detail below.

### SUMMARY OF THE DISCLOSURE

This disclosure relates to a gas-liquid spacer, capable of keeping the liquid pocket, present in the subsea line (non-piggable), separated from the natural gas injected in operations, where it is desired to remove the liquid in ascending flow, without the formation of hydrates and enabling the restart of oil production.

The spacer of this disclosure can be used in different oil and gas production scenarios in offshore fields, as it has the potential to be used in non-piggable, flexible and rigid lines; it can pass through diameter restrictions and reductions; it can be soluble in the oil phase; or it can be liquid at temperatures above 60° C.

In addition, the spacer of this disclosure has a very low cost, is easily available and has a high financial return for the business, as it does not require the hiring of a nitrogen generating unit and the return of oil and gas production in the short term.

The spacer of this disclosure: is a non-toxic product, so it does not cause any type of impact on the health of operators or on the safety of processes; it ensures the resumption of oil production in the short term, i.e., it avoids the closure of wells for several days due to the hiring and provision of a nitrogen generating unit; and it reduces environmental impact, as it reduces the use of Nitrogen Generating units (NGUs) in production facilities, reducing the risk of accidents and emissions from the system, which also generates financial gains.

Therefore, the gas-liquid spacer described in this document presents a condition that surpasses the state of the art and, therefore, enables unprecedented application as a natural gas-liquid spacer in a subsea line with production results far above expectations.

### BRIEF DESCRIPTION OF THE FIGURES

In order to make the disclosure easier to understand, the Figures numbered 1 to 12, which accompany this specification and are an integral part thereof, are presented for the purpose of illustration, but without the intention of limiting the disclosure.

FIG. 1 illustrates a train with products and metal spacers for cleaning the service line.

FIG. 2A shows a fracturing gel prepared with xanthan gum.

FIG. 2B shows the fracturing gel evaluated in a glass test unit.

FIG. 3A shows a representative chemical structure of the carbopol molecule and FIG. 3B shows the appearance of the alcohol gel.

FIG. 4A shows a representation of the chemical structures of paraffins and FIG. 4B shows paraffin vials produced at REDUC.

FIG. 5A shows a hypothetical representation of the chemical structure of a peptide and FIG. 5B shows the hydrogels prepared with different MEG contents.

FIG. 6 shows a crystal gel formed with air bubbles.

FIGS. 7A and 7B show a sample of CAT TINA 60% glycerin loaded in a rheometer for compression testing using a metal ring (7A-left) and without a metal ring (7B-right).

FIG. 8 shows the variation in the wall thickness of the prepared CATs.

FIG. 9 shows CATs of different sizes, wall thicknesses and geometry for evaluation.

FIG. 10 illustrates the profile of the service line of a well in the Campos Basin containing liquid.

FIG. 11 illustrates a glass test unit used to evaluate the performance of CAT CRIS and CAT TINA.

FIG. 12 illustrates a test unit used to evaluate the performance of CAT CRIS and CAT TINA as gas-liquid spacers, including: (i) 4″ and 42 cm sections of the underwater line to evaluate the impact of roughness on wall sealing; (ii) curved sections; and (iii) a sudden reduction in diameter from 4″ to 2″.

FIGS. 13 and 14 illustrate a test unit used to evaluate the performance of CAT CRIS and CAT TINA as spacers in 6″ and 4″ monodiameter conditions and with a reduction in diameter from 4″ to 2″.

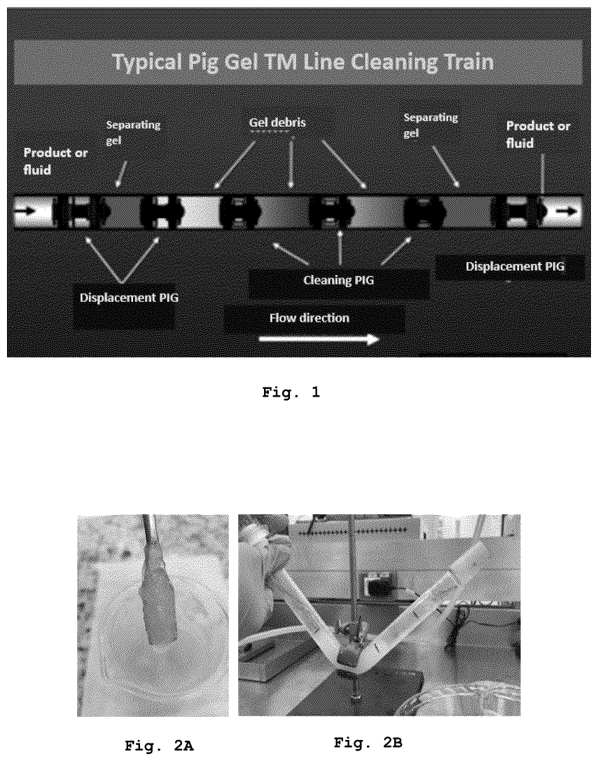

### OBJECTIVE OF THE DISCLOSURE

In embodiments, this disclosure aims to provide a gas-liquid spacer, which operates as a plug (liquid at high temperature and solid gel at low temperature) capable of keeping the liquid pocket, present in the non-piggable submarine line, separated from the natural gas, injected in operations where it is desired to remove the liquid in ascending flow.

In an additional embodiment, this disclosure aims to describe the use of a spacer, which prevents the formation of hydrates and enables the restart of oil production.

In another embodiment, this disclosure aims to describe the applications of a spacer in different oil and gas production scenarios, in offshore fields.

Further, in another embodiment, this disclosure aims to describe the characteristics of a spacer according to embodiments of the disclosure.

### DETAILED DESCRIPTION OF THE DISCLOSURE

This disclosure relates to a liquid-gas spacer, liquid at high temperature and solid gel at low temperature, which acts as a plug to prevent the passage of gas into the liquid, between the roughness of the flexible line. The spacer is capable of keeping the liquid pocket, present in the subsea line, separate from the natural gas, injected in operations, where it is desired to remove the liquid in ascending flow.

The use of said spacer prevents the formation of gas hydrates, even with the increase in pressure in the subsea line, and enables the resumption of oil production.

The spacer of this disclosure has applications in different oil and gas production scenarios in offshore fields, as it has the potential to be applied in non-piggable, flexible and rigid lines; is capable of passing through diameter restrictions and reductions; has solubility in the oil phase; or is liquid at temperatures above 60° C.

The gas-liquid spacer of this disclosure has many advantages over the spacers from the state of the art, namely: (i) low cost, easy availability and high financial return for the business by not hiring a nitrogen generating unit and resuming oil and gas production in the short term; (ii) non-toxic product, therefore, does not cause any type of impact on the health of operators or on process safety; (iii) guarantee of restarting oil production in the short term, i.e., it avoids the closure of wells for several days due to the hiring and provision of a nitrogen generating unit; and (iv) reduction of environmental impact, as it reduces the use of Nitrogen Generating units (NGUs) in production facilities, reducing the risk of accidents and emissions from the system, which also generates financial gains.

As previously mentioned, to avoid the formation of hydrates during the removal of liquids, pressure/depressurization cycles are performed in the line with nitrogen gas. However, this solution can only be operationalized by contracting a nitrogen generating unit (NGU) that is adapted to the production process. This procedure, p despite being efficient, is very expensive, due to the cost of contracting and, also, due to the dependence on the availability/prioritization of this unit, resulting in long periods of closed well and, consequently, significant losses in oil production. This condition is even more critical in wells with lower production flows or in more distant fields where prioritization is low.

The provision of the gas-liquid spacer, described herein, for production units (SPUs) aims to solve the problem of the state of the art to enable the immediate removal of liquid from the service line, promoting the return of oil production in the short term, that is, without the dependence on prioritizing the contracting of the Nitrogen Generating unit (NGU), generating high financial gains.

It is worth noting that this spacer can also be applied in other operations, such as line cleaning and decommissioning operations.

In order to enable the removal of liquid in the service line with natural gas, without the formation of gas hydrates—in this scenario of a non-piggable line—it was necessary to evaluate some materials with hydrate inhibition capacity.

In addition, with a more in-depth evaluation of the production scenario, other premises were established that the gas-liquid spacer would have to meet, increasing the challenges for its development. Among these characteristics, the following stand out: (i) it is a gel/solid product in low temperature conditions, with flexibility to vary in diameter from 4″ to 2″ to pass through the WCT; (ii) it is a product capable of preventing the passage of gas between the roughness of the flexible line; (iii) it is a product soluble in petroleum, or liquid at temperatures above 60° C.; and (iv) it should preferably disintegrate after passing through the WCT (Wet Christmas Tree).

Analyzing these premises, a search was made for a gas-liquid spacer that presented characteristics different from PIG gel and PIG foam, both reported in the state of the art as commercially available products.

Neither PIG gel nor PIG foam meet the most important requirement of being gas-tight in subsea line scenarios. This is because the PIG gel tends to settle in the horizontal sections, allowing the gas to pass through the upper generator of the line, while the PIG foam allows the gas to pass through the interior of the foam. Hence the importance of developing the gas-liquid spacer of this disclosure, herein designated as CAT (Chemicals and Technology).

Thus, the development of the present gas-liquid spacer was based on the selection of different products and their performance evaluation in acting as a plug, preventing the passage of gas to the liquid in low temperature conditions. The tests were carried out in bench test units, in the laboratory, on a 4″ diameter scale, equivalent to the underwater line of the production fields.

Table 2 presents a consolidation of the main fluids evaluated and their compositions. Each of the formulations presents different properties and will be described below.

TABLE 2
Fluids selected for performance evaluation as natural
gas-liquid spacer

| Fluid | Composition |
|---|---|
| Fracturing Gel | Xanthan gum, NaCl, industrial water, |
| | glutaraldehyde, anti-foaming agent, NaOH |
| Alcohol Gel | Carbopol polymer, ethanol and water |
| Hydrocarbon | Macro and microcrystalline paraffin and |
| | mineral oil |
| Hydrogel | Polymer, water and glycerin or MEG |
| Crystal Gel | Polymer, paraffin and mineral oil |

Main Fluids Evaluated and their Compositions

Fracturing gel—widely used in offshore well operations. It can have different compositions of xanthan gum or guar gum with water and ethanol. They are generally prepared on support vessels.

This type of gel was evaluated based on availability and experience of use, as shown in FIGS. 2A and 2B. However, in all cases studied, the formation of a heterogeneous mixture was observed, with the presence of lumps, high viscosity and adhesion of the fluid to the walls of the beaker and glass tube.

Alcohol gel—selected because alcohol is a hydrate inhibitor. This gel is a product prepared with the polymer carbopol in ethanol and water. The consistency of the gel varies according to the active matter content.

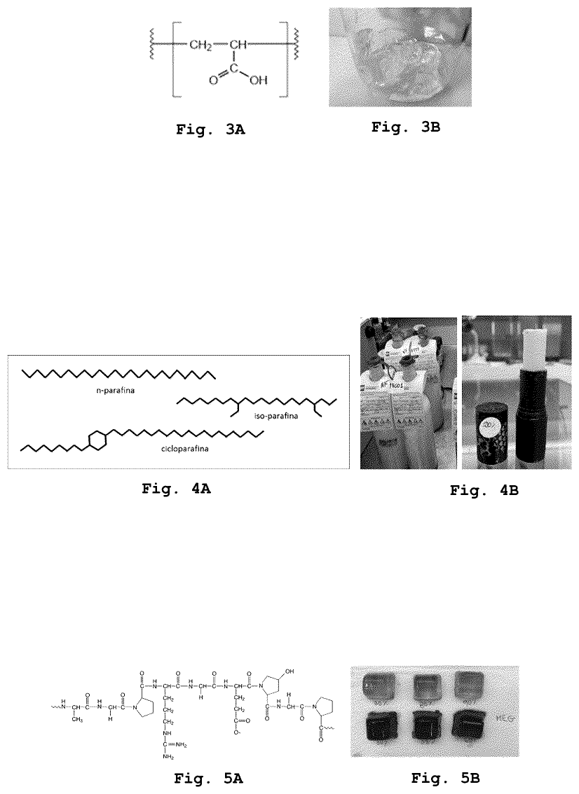

Two samples with different polymer concentrations, supplied by the company that develops chemical products, were evaluated, as shown in FIGS. 3A and 3B.

The products were selected because they have low viscosity, gel consistency at room temperature and can also prevent the formation of hydrates in the subsea line. Despite these advantages, they have slow solubilization kinetics in oil and do not form the plug.

Hydrocarbon—It is known that paraffin molecules (hydrocarbons), present in oil, behave like a liquid at high temperatures and like a solid at low temperatures. These characteristics were considered promising for developing the gas-liquid spacer.

Therefore, hydrocarbon molecules, with varied chemical structures, were selected because they present high solubility in oil, no affinity for water and rheological behavior characteristic of a liquid at high temperatures and a solid (gel) at low temperatures.

Initially, standard macro and micro crystalline paraffins were selected, and then paraffins produced at the Duque de Caxias Refinery (REDUC) were evaluated.

In microcrystalline paraffins, cyclic and branched molecules predominate, while in macrocrystalline paraffin, linear molecules predominate, as shown in FIGS. 4A and 4B. The analyses showed that the paraffin plug acts as a gas-liquid spacer, preventing the passage of gas to the liquid.

However, in tests performed on a rough surface, it was observed that the plug does not remain intact during the flow, leaving a trace of its structure in the line.

Hydrogel—A hydrogel or hydrocolloid is formed by polymers that form a three-dimensional structure of cross-links that are highly absorbent of water, usually called gelling agents.

Depending on the formulation and the ratio between the active substance and solvent content, this product can be liquid at high temperatures and form a gel/plug at low temperatures.

Despite low solubility in the oil phase, they generally present high flexibility and may be able to adjust to diameter reduction.

Some hydrogel formulations were prepared with different glycerin and MEG contents, as shown in FIG. 5B. Biopolymers were used for preparation, being a mixture of polypeptides and oligopeptides derived from the partial hydrolysis of collagen. The prepared formulations contain 10 to 40% biopolymers and 60 to 90% glycerin or MEG.

Crystal gel—In the search for a liquid product at high temperature, which forms a gel/plug at low temperature, is oil-soluble, resistant to line roughness and flexible to reduce the diameter by half, a mixture of polymer, paraffin and solvent was selected, here designated as crystal gel. Depending on the active matter content (polymer), this product will have different consistencies and can be considered soft gel and hard gel. In this sense, the concentrations of active matter (polymer) can vary from 10 to 30%.

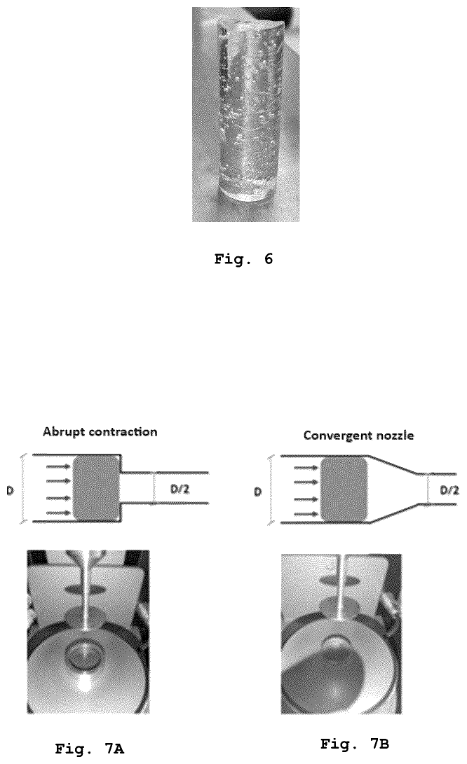

The preparation of CAT CRIS with this product also included preparation with air bubbles, keeping the mixture under agitation during cooling, as shown in FIG. 6.

Additionally, the compressibility of CAT samples of different formulations was evaluated in a rotational rheometer (DHR3-TA Instruments), in compression tests by monitoring the normal force as a function of the height of the parallel plate geometry (D=20 mm), at a descent speed of 5.0 μm/s.

The methodology makes use of the ability of the rheometer to capture normal force (NF) variation in the range of 0.01 N to 50 N. The test temperature was maintained at 25° C. However, in order the samples be correctly loaded into the equipment, prior solubilization was necessary. Then, the fluid sample was loaded inside a metal ring with a diameter of 20.5 mm positioned concentrically to the parallel plate geometry. During the tests, the premise was adopted that the materials have isotropic behavior. Therefore, it can be said that the mechanical and thermal properties of each sample are the same in all directions.

Table 3 shows a comparative chart of the requirements met by each of the main fluids evaluated as a natural gas-liquid spacer. The results in Table 3 were obtained after numerous tests in the glass test unit, the most relevant results of which were obtained at a temperature of 4° C.

### Table 3—Fluids Selected for Performance Evaluation as a Natural Gas-Liquid Spacer

| | Gas- | Oil | | | |
|---|---|---|---|---|---|
| | water | soluble | Roughness | 1/2 D | |
| Product | spacer | (80° C.) | anchoring | adjustment | Note |
| Xanthan | [symbol] | [symbol] | [symbol] | [symbol] | Adheres to |
| gum | | | | | wall/prepares |
| | | | | | in stages, |
| | | | | | lays |
| | | | | | horizontally |
| Alcohol | [symbol] | [symbol] | [symbol] | [symbol] | Commercial/ |
| gel 3 | | | | | gel at room |
| (carbopol) | | | | | temperature. |
| CAT | | | | | Valid from |
| | | | | | D-d and non- |
| | | | | | d-D |
| Paraffin/ | [symbol] | [symbol] | [symbol] | [symbol] | Monodiameter |
| mineral | | | | | smooth |
| oil | | | | | surface |
| CAT BATON | | | | | |
| Hydrogel | [symbol] | [symbol] | [symbol] | [symbol] | Liquid at |
| (70%) | | | | | 80° C., but |
| CAT TINA | | | | | separates |
| | | | | | from the oil, |
| | | | | | valid D-d |
| Hard | [symbol] | [symbol] | [symbol] | [symbol] | Under d-D |
| paraffin | | | | | evaluation |
| gel | | | | | |
| CAT CRIS | | | | | |

[symbol]

Approved [symbol]
Restriction [symbol]
Disapproved

From the table above, it is possible to observe that, among the fluids evaluated, CAT CRIS met all the premises imposed for the tests; however, an adjustment in the formulation of CAT TINA, from 70% to 80% in glycerin, and changes in the format indicated that it would also be able to meet the diameter reduction requirement (D-d).

Also from the table above, Alcohol Gel 3 (CAT), despite having been approved in 3 parameters, in the evaluated concentrations did not present adequate consistency in the performance evaluation tests, not remaining as a plug.

The CAT and CRIS CAT TINA spacers were manufactured with different geometric shapes, which can be adjusted according to the application. The basic configuration was defined as: diameters of 4″ and 6″, length being twice the diameter (L=2D), which can vary according to the application and, also, different geometric shapes, such as: straight and conical tip, open and closed internal section, with different depths, as exemplified in FIG. 9.

### CAT Preparation Procedure and Sample Compression Test

The CAT preparation procedure followed the following steps:

a) preheating the sample to 80° C. for 30 minutes in a circulation oven;
b) loading the sample inside the metal ring on a plate;
c) conditioning at 10° C. for 30 minutes to harden the material;
d) conditioning at 25° C. for 5 minutes.

The sample compression test was performed after the CAT preparation procedure described above. In it, the geometry height variation was defined in the interval between the contact point of the geometry with the sample (NF˜0.01 N) and the height corresponding to the normal force sensor limit (NF˜50 N).

Before performing the compression test in a controlled manner, however, a screening was performed to define the achievable height range. Next, the geometry was positioned at the contact point with the sample and the descent was programmed at a constant speed of 5.0 μm/s to the previously established point, close to the normal force sensor limit.

In addition to the compression test with the sample loaded inside the metal ring, a second type of test, this time with the free sample, was also performed.

The same experimental protocol described above was adopted in both tests, but the behaviors were different.

In operational terms, the test using the ring (7A) represents the attempt to pass the CAT material through an abrupt contraction, where, for example, the diameter of the pipe is suddenly reduced by half. The test without the ring (7B) represents the transport of the material through a convergent nozzle, where the diameter is reduced slowly and gradually, as shown in FIGS. 7A and 7B.

In these tests, the fluids were initially evaluated with cylindrical geometry. However, the tests allowed us to conclude that other types of geometry may favor the flow in the line and the flexibility to pass through sections of smaller diameters.

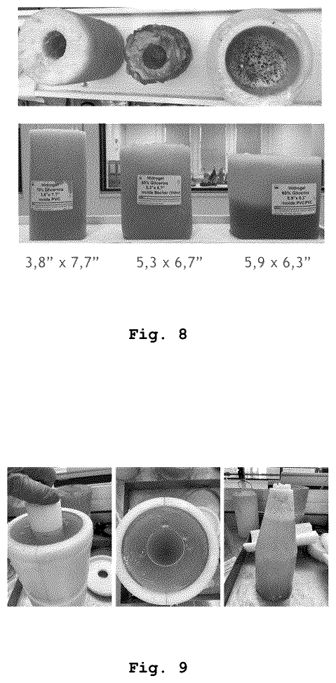

In this stage, some geometric shapes were also evaluated, considering: sharp tip; empty interior, different wall thicknesses; and filled with liquid (MEG). Other artifacts were also evaluated, such as: the presence of air bubbles (6) and polystyrene balls. The variation in the wall thickness of the prepared CATs can be seen in FIG. 8. It was observed that the thinner the thickness, the greater the flexibility, but also the lower the resistance.

In order to obtain the gas-liquid spacer described herein, several tests were developed, some of which will be reported below in the form of Examples and Results.

### Examples and Results

A well in the Campos Basin was selected for this study, the production potential of which was 535.1 m³/d with BS&W of 31.2% and RGO of 141.7 m³/m³ and was closed with significant production loss.

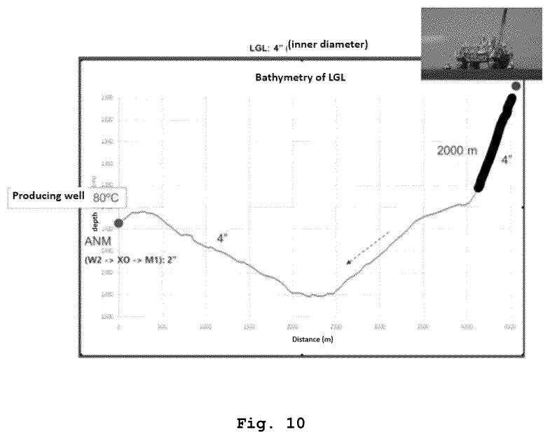

The production line of the referred well, with a diameter of 8″, has a volume of 174 m³ and the service line of the referred well, of 4″, has a volume of 46 m³. The liquid accumulated in the service line should be pushed to the production column through the Wet Christmas Tree (WCT), the inlet of which has a 2″ opening, and mixed with the produced fluid, as shown in FIG. 10.

In this scenario, the removal of liquid to the surface was performed by pressurization/depressurization cycles, with nitrogen, through the service line (HCR)->Wet Christmas Tree (WCT)->Surface (platform).

After months with the well closed awaiting the availability of the NGU, an alternative was devised to restart production using a gas-liquid spacer between the natural gas and the liquid present in the line.

Regarding the results in Table 3, it is possible to verify that two formulations were approved, here called CAT CRIS and CAT TINA.

CAT TINA is a hydrogel prepared with polymers (e.g. pectin, carrageenan and gelatin) that form a three-dimensional cross-linked structure, highly absorbent of water. Depending on the formulation, this product can be liquid at high temperature (from 60° C.) and form gel/plug at low temperature (around 4° C., minimum temperature of seawater on the seabed). In general, they present high flexibility and can be adjusted to reduce diameter. Some hydrogel formulations have been prepared with different contents (60 to 90%) of glycerin and MEG.

In the search for a high-temperature liquid product that forms a gel/plug at low temperatures, is oil-soluble, resistant to line roughness and flexible to reduce the diameter by half, CAT CRIS was developed, formulated from a mixture of polymer, paraffin and mineral oil.

Depending on the active ingredient content, this product will have different consistencies and can be considered a soft gel or a hard gel. The preparation of CAT CRIS also included the inclusion of air bubbles.

### Performance Evaluation Tests of Gas-Liquid Spacers

Performance evaluation tests of gas-liquid spacers were carried out by placing the spacer and saline water with yellow dye and/or diesel in the test unit, shown in FIG. 11, followed by the injection of compressed air from the laboratory bench into one end of the tube at a temperature of 4° C.

The spacer formulation was considered adequate, qualitatively, when there were no air bubbles in the aqueous phase, confirming that the spacer did not allow air to pass into the liquid. In these tests, the spacers were evaluated in different concentrations of active matter (10 to 30%) in single-diameter tubes and tubes of different diameters.

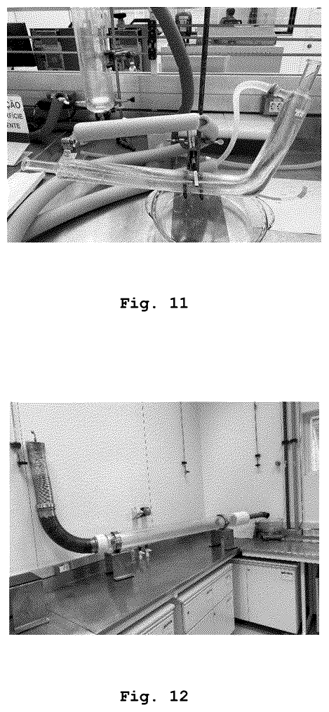

After the approval of the formulations in the glass test unit (FIG. 11), some formulations were selected to be tested on a scale closer to the field scenario. To make this evaluation feasible, it was necessary to assemble a unit with a diameter of 4″ including: (i) sections of the underwater line, measuring 4″ and 42 cm, to evaluate the impact of roughness on the wall sealing; (ii) curved sections; and (iii) a sudden reduction in diameter from 4″ to 2″, as shown in FIG. 12.

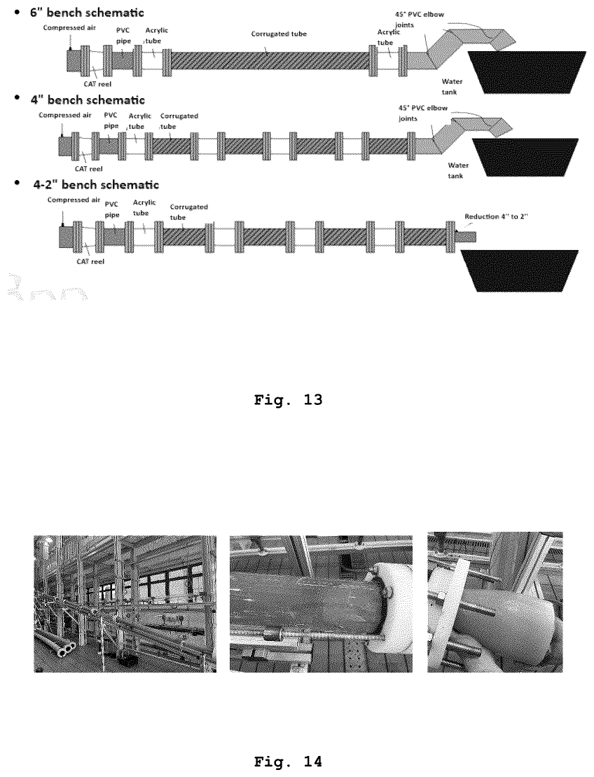

The CATS TINA and CRIS were also evaluated in a 12-meter flow unit to validate their performance, in a 6″ and 4″ monodiameter condition and with a reduction in diameter from 4″ to 2″, as shown in the schematic drawing shown in FIG. 13 and the photo in FIG. 14. The results obtained validated the performance of the formulations as gas-liquid spacers.

### Solubility Tests of Gas-Liquid Spacers

Additionally, the developed CATS were immersed in mineral oil at 80° C. in an oven to evaluate their solubility in this phase. In these tests, it was observed that the CAT CRIS solubilizes in the oil phase after 6 minutes. On the other hand, CAT TINA, despite not being solubilized in the oil phase, has been shown to be liquid at temperatures above 60° C.

The description made so far of the present gas-liquid spacer, as well as its examples of embodiment, should be understood as not limiting the disclosure, which is limited only to the scope of the claims that follow.

1. A gas-liquid spacer for removal of liquid from subsea lines, the spacer comprising:
a material soluble in oil or liquid at temperatures above 60° C.,
the material also being a solid gel at a low temperature, with flexibility to vary in diameter from 4″ to 2″ to pass through a Wet Christmas Tree (WCT) and disintegrate after passing through the WCT, and
the spacer operating as a plug to prevent passage of natural gas to liquid, between the roughness of the flexible underwater line, in low temperature conditions, so as to prevent formation of gas hydrates, even with increased pressure in a subsea line, so as to operate in non-piggable, flexible and rigid lines, of different diameters, and so as to be able to pass through diameter restrictions and reductions.

2. The gas-liquid spacer according to claim 1, wherein the space is injected in operations where it is desired to remove the liquid in ascending flow to enable restart of oil production.

3. The gas-liquid spacer according to claim 1, wherein the space is defined as CAT CRIS and has the following characteristics:
being a liquid product at high temperature above 60° C., forming a gel/plug at low temperatures, and being soluble in oil, resistant to the roughness of the flexible line, and capable of reducing up to half the diameter,
being formulated from a mixture of polymer, paraffin and mineral oil, and
depending on the active matter content, the spacer has different consistencies so as to be one of soft gel or hard gel.

4. The gas-liquid spacer according to claim 1, wherein the spacer is defined as CAT TINA and has the following characteristics:
being formulated from a hydrogel, prepared with polymers that form a three-dimensional structure of cross-links that is highly absorbent of water, and
depending on the formulation, the spacer comprises liquid at high temperatures above 60° C. and a gel/plug at low temperatures of about 4° C., so as to provide high flexibility and adjust to reduction in diameter.

5. The gas-liquid spacer according to claim 4, further comprising the CAT TINA presents in some of its hydrogel formulations different contents of glycerin and MEG in a range of about 60% to about 90%.

6. The gas-liquid spacer according to claim 3, further comprising both CAT CRIS and CAT TINA have been manufactured with the following basic configuration, which is adjusted according to the application: diameters of 4″ and 6″; length being twice the diameter (L=2D), which varies according to the application, and different geometric shapes; and wherein the different geometric shapes include one or more of straight and conical tip, open and closed internal section, with different depths.

7. The gas-liquid spacer according to claim 1, further comprising applying the spacer in different oil and gas production scenarios, in offshore fields, by presenting one or more of: potential for application in non-piggable, flexible and rigid lines; being able to pass through diameter restrictions and reductions; having solubility in the oil phase; or being liquid at temperatures above 60° C.

8. A method of use of a gas-liquid spacer for removing liquid from subsea lines as defined in claim 1, further comprising:
operating as a plug to prevent the passage of gas to liquid, between the roughness of the flexible line, in low temperature conditions,
preventing the formation of gas hydrates, even with the increase in pressure in the submarine e line even at low temperature, and
being used in non-piggable, flexible and rigid lines.

9. The method according to claim 8, further comprising being further applied in other operations, including one or more of line cleaning or decommissioning operations.
